(19) United States
(12) Patent Application Publication
(10) Pub. No.: US 2026/0335927 A1
(43) Pub. Date: Oct. 29, 2026

(54) MATERIAL-AMOUNT REGULATING DEVICE FOR LIMITING THE MATERIAL NEEDLE STROKE OF A SPRAY GUN, SPRAY GUN HAVING A MATERIAL-AMOUNT REGULATING DEVICE, AND METHOD FOR APPLYING COATING MATERIAL

(71) Applicant: SATA GmbH & Co. KG, Kornwestheim (DE)

(72) Inventor: Alexander TSCHAN, Kornwestheim (DE)

(73) Assignee: SATA GmbH & Co. KG, Kornwestheim (DE)

(21) Appl. No.: 19/110,189

(22) PCT Filed: Jul. 20, 2023
(86) PCT No.: PCT/EP2023/070183

§ 371 Date: Aug. 8, 2025

(30) Foreign Application Priority Data
Sep. 12, 2022 (DE) 10 2022 123 186.0

(51) Int. Cl. B05D 1/02; B05B 12/00

(52) U.S. Cl. CPC B05D 1/02; B05B 12/0022

(57) ABSTRACT

A material-amount regulating device limits the material-needle stroke of a hand-held spray gun. The device includes a front end with a holding member for attaching the material-amount regulating device to a spray gun; a rear end opposite the front end; a stop surface for limiting the material-needle stroke; an adjustment member, which in reciprocation with a corresponding counter element of the spray gun, an axial position of the stop surface can be axially shifted for limiting the stroke; a rapid adjustment mechanism, by means of which the stop surface can be shifted, relative to the adjustment member, in the axial direction, between a stroke-limiting position and a stroke-opening position, without changing the axial position of the stop surface adjusted by the adjustment member and without removing the material-amount regulating device from the spray gun.

### FIELD OF THE INVENTION

The invention relates to a material-amount regulating device for limiting the material-needle stroke of a spray gun, comprising a front end having a holding means used to fasten the material-amount regulating device to a spray gun, a rear end which is opposite the front end, a stop surface for limiting the material-needle stroke, an adjustment means which, by interacting with a corresponding counter element of the spray gun, can adjust an axial position of the stop surface for limiting the material-needle stroke relative to the spray gun, and a rapid adjustment mechanism, by means of which the stop surface can be shifted back and forth in the axial direction relative to the adjustment means between a stroke-limiting position and a stroke-opening position, which is different than the stroke-limiting position, without changing the setting of the adjustment means and without removing the material-amount regulating device from the spray gun.

Furthermore, the invention relates to a spray gun for dispensing a coating material, comprising a material needle and a material-amount regulating device for limiting the material-needle stroke, as well as to a method for applying coating material by means of a spray gun.

### BACKGROUND

Material-amount regulating devices are used, for example, in the field of painting technology, where they serve to provide a stop for the end of a material needle that controls the amount of material dispensed, which end is opposite the material dispensing direction, by means of a stop surface. As a rule, material-amount regulating devices are fastened to the end of the spray gun that is opposite a material nozzle of the spray gun in the material dispensing direction. These are usually fastened by means of a bore in the body of the spray gun, which has an internal thread. The material-amount regulating device has a corresponding external thread and is screwed into the bore. By changing the screw-in depth of the material-amount regulating device, the stop of the material-amount regulating device can be moved back and forth in the axial direction, as a result of which the maximum material-needle stroke of the material needle can be limited to a greater or lesser extent.

For some applications or certain coating materials, it is desirable to limit the amount of material dispensed, for example to achieve a special surface effect. For other application, the maximum amount of material must, in turn, be dispensable. For this purpose, it is advantageous to be able to quickly switch back and forth between two positions. Such a switchable material-amount regulating device is known from JPH4126562.

JPH4126562 describes a material-amount regulating device used to switch back and forth between a fully open position and a half-open position. In particular, this is intended to allow unskilled workers to achieve a high surface quality. This is to be achieved not by applying a single layer in the fully open position as is standard, but by applying multiple layers with the same layer thickness in the half-open position. For small or rough surfaces, skilled workers are to apply multiple layers of equal thickness in the half-open position. For switching, the rear end of the material-amount regulating device is pushed forward in the material dispensing direction, then rotated by 90° and pushed backward again.

Such solutions meet the requirement of quickly switching back and forth between a first position of the stop surface and a second position of the stop surface. However, due to its design, the material-amount regulating device is particularly bulky and cannot be mounted on a conventional spray gun without modifications. Also, when the material-amount regulating device is removed, the end of the material needle remains concealed in the gun body of the spray gun, making it difficult to remove.

### SUMMARY OF THE INVENTION

Proceeding from this, one aspect of the invention is that of providing a compact material-needle regulating device. Another aspect of the invention is to provide a spray gun with a corresponding material needle regulating device and a corresponding method for applying coating material using a rapidly adjustable material-amount regulating device.

A material-amount regulating device can be used in spray guns that substantially consist of a main body with a gun handle, a nozzle head, a trigger and a material conducting system with a material needle and a material-amount regulating device for setting the maximum material-needle stroke, by means of which the amount of material to be dispensed can be determined. It can also be an automatic spray gun that has no gun handle or trigger and is operated automatically by means of a trigger mechanism.

These spray guns can be pressure-atomizing spray guns or air-atomizing spray guns. In the case of pressure atomizing spray guns, the material to be atomized is placed under high pressure and the material is atomized by interacting with the ambient air when the material exits the mouth of the material nozzle under high pressure. Air atomizing spray guns also feature an air supply connection, by means of which a compressed air supply can be connected, compressed air ducts for conducting the compressed air, an air conducting system with an air valve and an air-volume regulating device for setting the compressed air volume. In the case of an air atomizing spray gun, the compressed air required for atomization is supplied to the air supply connection, which is located on or in the gun handle. By pulling the trigger to a first pressure point, the air valve is opened. By pulling the trigger further, the material needle is also pulled out of the material nozzle. The coating agent then flows out of the material nozzle due to gravity or a pressure difference and is atomized by the compressed air emerging from the air nozzle, which is designed as an annular gap and surrounds the material nozzle, and is transported in the material dispensing direction to an object to be coated, on which the material settles and forms a coating film.

The nozzle head of such a spray gun has a material-guiding region through which the material to be atomized flows from a coating agent inlet to a material nozzle. A material supply is provided at the coating agent inlet, which can be provided, for example, as a storage container or a supply line from an external material storage facility. Common storage containers include flow cups, suction cups or side cups. The pressure difference required to convey the material is created, for example, by gravity or by a material conveying apparatus that pressurizes the material to be conveyed. The material can also be conveyed by negative pressure, which is generated by air flowing past the material nozzle, causing a suction effect to act on the material.

Such spray guns offer the user a variety of adjustment options. The volume flow rate of the air can be set using an air-volume regulating device. A round/wide jet regulator allows the jet shape of the aerosol emerging from the spray gun to vary. For this purpose, two or more horns with horn air nozzles are provided on the nozzle head, which are diametrically opposite the material nozzle. The horn air nozzles point inward toward the emerging coating material jet. If no air flow emerges from the horn air nozzles, the coating material jet can evenly propagate laterally in all directions after exiting the nozzle and forms a material jet with a round cross section. If air flows out of the horn air nozzles, the coating material jet is formed into a material jet with an elliptical cross section after exiting the material nozzle.

The material-amount regulating device limits a side of the path on which the material needle can move along its own axis. On the opposite side, this path is limited by the material nozzle. The further the stop surface of the material-amount regulating device is moved in the material dispensing direction, the more it shortens the distance that the material needle can move when the trigger is actuated, thereby limiting the maximum material volume flow. When the trigger is not actuated, the material needle is held in the material nozzle by the compression spring, thereby sealing it. When the trigger is pulled, the material needle is moved out of the material nozzle and continues to release it.

According to the invention, a material-amount regulating device for limiting the material-needle stroke of a spray gun, preferably a hand-held one, is proposed. The material-amount regulating device has a front end comprising a holding means, in particular in the form of a thread, used to fasten the material-amount regulating device to a spray gun. Opposite the front end is a rear end. Furthermore, the material-amount regulating device has a stop surface for limiting the material-needle stroke, an adjustment means, in particular formed by part of the holding means designed as a thread, which, by interacting with a corresponding counter element of the spray gun, axially moves an axial position of the stop surface intended for limiting the material-needle stroke relative to the spray gun. Furthermore, the material-amount regulating device comprises a rapid adjustment mechanism by means of which the stop surface can be shifted back and forth in the axial direction relative to the adjustment means between a stroke-limiting position and a stroke-opening position that is different than the stroke-limiting position. In this case, the setting of the adjustment means or the axial position of the stop surface set by means of the adjustment means is not changed and the material-amount regulating device is not removed from the spray gun. The stop surface is arranged, at least in the stroke-limiting position, at the level of the holding means in the axial direction or is offset in the axial direction relative to the holding means in the direction of the rear end of the material-amount regulating device. “Without removing the material-amount regulating device” is understood such that the material-amount regulating device is not removed from the spray gun, but remains connected thereto. Preferably, the stop surface is located closer to the front end of the material-amount regulating device in the stroke-limiting position than in the stroke-opening position. This design of a material-amount regulating device allows for a particularly compact design, which makes handling easier for the user.

The stroke-opening position can be understood to mean a position of the material-amount regulating device in which the stop surface does not limit, or only marginally limits, the axial movement of the material needle of the spray gun when dispensing coating material. Accordingly, the trigger of the spray gun can be actuated up to a position in which said maximum amount is dispensed. The stroke-limiting position can be understood as a position of the material-amount regulating device in which the stop surface of the material-amount regulating device limits the axial movement of the material needle of the spray gun in such a way that the material needle of the spray gun can only be axially moved counter to the material dispensing direction to such an extent that a reduced amount of coating material can be dispensed compared to the maximum amount of coating material dispensed in the stroke-opening position. Preferably, the amount of coating material that can be dispensed in the stroke-limiting position is more than one third, in particular more than half, of the coating material that can be dispensed in the stroke-opening position. Particularly preferably, more than two thirds, preferably more than 80%, of the maximum amount of material can be dispensed in the stroke-limiting position.

In a further preferred embodiment, the material-amount regulating device has a front end and a rear end that is opposite the front end, wherein the front end has a holding means and an adjustment means, wherein the adjustment means extends from the front end toward the rear end. Furthermore, a stop surface for limiting the material-needle stroke as well as a rapid adjustment mechanism that is separate from the adjustment means are provided, by means of which the stop surface can be shifted back and forth relative to the holding means in the axial direction between the stroke-limiting position and the stroke-opening position, which is different than the stroke-limiting position. In this case, the stop surface is arranged at the level of the holding means in the axial direction, at least in the stroke-limiting position, or is offset in the axial direction relative to the holding means toward the rear end of the material-amount regulating device. Since the stop surface is offset to the rear in relation to the adjustment means in this design, a particularly compact design can also be achieved, which makes handling easier for the user.

In a particularly preferred embodiment, at least in the stroke-limiting position, the stop surface is located at the level of the adjustment means in the axial direction or is offset in the axial direction relative to the adjustment means toward the rear end of the material-amount regulating device, preferably arranged closer to the rear end than to the front end of the material-amount regulating device. In addition, in the stroke-opening position, the material-amount regulating device can also be arranged at the level of the adjustment means or offset relative to the adjustment means toward the rear end of the material-amount regulating device, preferably arranged closer to the rear end than to the front end of the material-amount regulating device. This design has the advantage that the stop surface for the material needle of the spray gun is moved further back, which further shortens the required length of the material-amount regulating device, resulting in an even more compact design. Preferably, the material-amount regulating device is designed such that the material needle of the spray gun, when the trigger is pulled, projects into the material-amount regulating device over at least half the length of the material-amount regulating device, preferably over at least two thirds of the length of the material-amount regulating device.

Particularly preferably, the material-amount regulating device has a cavity which extends from the front end of the material-amount regulating device, in the direction of the rear end of the material-amount regulating device and into the interior of the material-amount regulating device and is designed to receive a material needle of the spray gun. Said cavity increases the space for the material needle of the spray gun within the material-amount regulating device, which further reduces the design of the material-amount regulating device.

Preferably, the material-amount regulating device is designed such that the stop surface is located closer to the front end of the material-amount regulating device in the axial direction in the stroke-opening position than in the stroke-limiting position. In this case, the stop surface in the stroke-limiting position is preferably positioned within the half of the material-amount regulating device which comprises the rear end of the material-amount regulating device. Since the stop surface is located particularly far at the rear end of the material-amount regulating device even in the stroke-limiting position, a particularly compact design is possible.

In another preferred embodiment, a locking means is provided, by means of which the material-amount regulating device can be locked in a position relative to the spray gun in the axial direction that is set by the adjustment means, wherein the locking means is preferably designed as a lock nut. This reduces the risk of the adjustment device accidentally moving.

Preferably, the material-amount regulating device has an adjustment element, in particular a sleeve-shaped adjustment element, which comprises the adjustment means. Furthermore, a stop element, in particular a sleeve-shaped stop element, is preferably provided, which comprises the stop surface. Preferably, the stop element and the adjustment element are displaceable relative to one another in the axial direction. In this case, the stop surface and preferably the entire stop element are mounted so as to be axially movable relative to the adjustment element between the stroke-limiting position and the stroke-opening position.

Particularly preferably, the stop element is at least partially arranged inside the adjustment element and/or the adjustment element is at least partially arranged inside the stop element. The nested design creates a particularly compact material-amount regulating device, which requires very few parts and provides a large interior space for receiving the material needle of the spray gun.

In a further particularly preferred embodiment, the stop element and the adjustment element each have a shoulder which abut one another in the stroke-opening position. The shoulders of the stop element and the adjustment element create a particularly simple maximum stop for the stroke-opening position, which does not require any additional parts.

Preferably, the material-amount regulating device is designed such that the stop surface is moved by means of the rapid adjustment mechanism, preferably exclusively by the stop surface moving in the axial direction and/or the stop surface is moved by means of the adjustment means by a screwing movement around the central axis of the material-amount regulating device. Said displacement movements make the rapid adjustment mechanism particularly easy to operate, wherein the adjustment device can be operated with particular precision.

Particularly preferably, the rapid adjustment mechanism is designed in such a way that it automatically locks in the stroke-limiting position and/or the stroke-opening position. This automatically protects the rapid adjustment mechanism from moving back, which improves the functional reliability of the rapid adjustment mechanism.

Preferably, the rapid adjustment mechanism comprises a securing element which serves to lock the rapid adjustment mechanism in the stroke-limiting position and/or the stroke-opening position, wherein the securing element preferably at least partially surrounds the adjustment element and/or the stop element in the circumferential direction. Said securing element prevents the selected stroke-opening position or stroke-limiting position from being automatically adjusted.

In a particularly preferred embodiment, the rapid adjustment mechanism automatically moves from the stroke-limiting position to the stroke-opening position by retracting a securing element. The automatic movement from the stroke-limiting position to the stroke-opening position is preferably carried out by means of a force which acts on the stop element in the axial direction away from the front end of the material-amount regulating device and is generated by a spring element. This can be achieved by using either a spring element within the material-amount regulating device or a spring element within the spray gun, which moves the material needle back into the sealing seat of the material valve when the material valve is open.

In a further particularly preferred embodiment, the material-amount regulating device has a sleeve-shaped adjustment element and a sleeve-shaped stop element, regions of which are arranged within the adjustment element and which is mounted coaxially on the inner surface of the sleeve-shaped adjustment element.

In a particularly preferred development, the adjustment element is provided with an external thread which forms the holding means and the adjustment means. A locking device in the form of a lock nut can be provided on the external thread. The adjustment element allows the axial position of the stop surface in the stroke-limiting position and the stroke-opening position to be adjusted using the thread.

In a further embodiment, the stop element may be closed at an end opposite the front end of the material-amount regulating device and the stop surface may be formed on the inner side of the closed end.

In an advantageous development of the invention, in a region of the open end of the stop element that is opposite the closed end, the outer surface of the stop element can be provided with a shoulder which, in the stroke-opening position in which the inner stop element is moved as far as possible in the direction of the rear end of the material-amount regulating device, comes to rest with a shoulder on the inner surface of the adjustment element and blocks the stop element from moving in the axial direction from the front end of the material-amount regulating device toward the rear end of the material-amount regulating device.

In a preferred variant of the invention, the stop element can have a circumferential groove in the region of the closed end and the adjustment element can have bores in the rear region in which balls are mounted so as to move radially to the axial direction, wherein, in a securing position, the position of the bores is at the same level as the position of the circumferential groove in the axial direction and the stop element is moved within the adjustment element toward the front end.

In a further embodiment, an additional sleeve-shaped securing element can be provided which surrounds the region of the rear end of the material-amount regulating device in the region of the bores and the circumferential groove. The securing element can have a larger opening inner diameter at the front when viewed in the axial direction and a smaller securing inner diameter at the rear when viewed in the axial direction.

An embodiment in which the securing element is mounted on the adjustment element and/or the stop element so as to move in the axial direction such that it can be shifted back and forth in the axial direction between the securing position and the opening position is particularly preferred. In the securing position, the circumferential groove, the bores and the securing inner diameter can be at the same level in the axial direction, whereas, in the opening position, the circumferential groove, the bores and the opening inner diameter can be at the same level in the axial direction.

In the securing position, the balls can be pressed into or engage in the circumferential groove of the stop element, wherein the mobility of the balls in the radial direction and away from the central axis of the material-amount regulating device, is limited by the smaller securing inner diameter in such a way that they are held in engagement with the circumferential groove, thereby preventing the stop element from moving axially relative to the material-amount regulating device.

In the opening position, due to the larger opening inner diameter, the balls can be deflected outward in the radial direction away from the central axis of the material-amount regulating device to such an extent that the balls no longer engage in the circumferential groove, whereby the stop element can be moved back and forth in the axial direction relative to the adjustment element between the opening position and the securing position.

In a particularly preferred embodiment, a spring element can be provided which exerts a force directed in the axial direction and in the direction of the rear end of the material-amount regulating device from the securing element to the stop element, which force automatically shifts the stop element backward in the opening position and holds it in this opening position.

The spring element can exert a force on the securing element in the axial direction and toward the front end of the material-amount regulating device, which force automatically moves the securing element forward and holds it in the securing position, thereby keeping the balls engaged with the groove.

The above-mentioned design features make it possible to create a material-amount regulating device that is particularly compact and particularly easy to operate. Such a material-amount regulating device on an existing spray gun can also be replaced with a conventionally mounted material-amount regulating device without having to make any changes to the spray gun. Conventional material needles can also be used without adjusting the length of the material needle. This means that no additional parts need to be manufactured, reducing production costs.

The invention further relates to a spray gun for dispensing a coating material, in particular a hand-held spray gun, comprising a material needle and a material-amount regulating device for limiting the material-needle stroke having one or more of the aforementioned features, wherein the material-amount regulating device is preferably fastened directly to the spray gun or via at least one intermediate component. The fastening element by means of which the material-amount regulating device is fastened to the spray gun can also be used to set the stroke-limiting position. For example, the material-amount regulating device is fastened by means of an external thread thereon and an internal thread which is provided in a channel of the spray gun surrounding the material needle. If the material-amount regulating device is screwed in or unscrewed using the thread, the position of the stop surface can be adjusted in the axial direction. Such a spray gun with such a material-amount regulating device can be used to switch back and forth between the stroke-limiting position and the stroke-opening position particularly quickly and reliably, which makes operation of the spray gun easier.

In a further preferred embodiment of a spray gun, in the stroke-limiting position, the stop surface limits the maximum axial deflection of the material needle toward the rear end of the material-amount regulating device in such a way that a reduced amount of coating material can be dispensed compared to in the stroke-opening position. Preferably, the maximum deflection of the material needle in the axial direction and in the direction of the rear end of the material-amount regulating device in the stroke-opening position is not limited by the stop surface such that the maximum possible amount of coating material can be dispensed. Dispensing the maximum possible amount of coating material is preferably understood to mean an amount in which the quantity of dispensable coating material can no longer be reduced or can only slightly be reduced by limiting the material-needle stroke. In this context, “slightly” is preferably understood to mean a reduction of less than 5% in the maximum amount of material that can be dispensed. Thus, the maximum amount of material that can be dispensed in the stroke-opening position is preferably significantly limited by the design of the material nozzle and not by the material-needle stroke.

The invention further relates to a method for applying coating material by means of a spray gun, in particular a spray gun with one or more of the features described above and/or a material-amount regulating device with one or more of the features described above. As a rule, the material-amount regulating device is initially moved by means of an adjustment element into a closed position beforehand, in which a stop of the material-amount regulating device for a material needle of the spray gun is moved as far as possible in the material dispensing direction. This state forms a zero point or starting position. The material-amount regulating device can be completely closed in this state. A stop surface of the material-amount regulating device can also completely block a material needle of the spray gun from moving in the axial direction.

Within the context of the method according to the invention, the material-amount regulating device is placed by means of the adjustment element into a stroke-limiting position in which the stop surface allows the material needle to move in the axial direction as far as a freely definable intermediate position in which a reduced amount of material can be dispensed. This is followed by the actuation of a rapid adjustment mechanism of the material-amount regulating device, by means of which the stop surface is moved from the stroke-limiting position to a stroke-opening position without the adjustment element being actuated, in which stroke-opening position the material needle can be opened in the axial direction as far as a maximum position and the amount of material that can be dispensed has not been reduced or has been reduced to a lesser extent. The next step is the application of a coating material layer to an object to be coated that has the maximum possible amount of dispensed material (that has not been reduced). After the lower layer of material has been applied, the rapid adjustment mechanism is actuated, by means of which the stop surface is transferred to the stroke-limiting position in which the reduced amount of material can be dispensed. The adjustment element is not actuated here. The next step is the application of another layer of coating material with a reduced amount of dispensed material. By means of said method, a lower material layer with a greater layer thickness is first applied, after which an upper material layer is applied, which preferably has a smaller layer thickness due to the reduced amount of material. By means of such a method, a coating material layer can be reproducibly applied, preferably with two different layer thicknesses, wherein particularly high surface quality can be achieved by means of the upper layer with the smaller layer thickness. Various effects are also more visible with a smaller layer thickness. Unlike applying multiple identical thin layers of material, work can be carried out more quickly and there is no risk of the coating material drying out before the coating process is completed. Unlike the method described, different coating materials can also be used for both layers. Additional layers of different thicknesses can also be applied.

The invention further relates to a method for applying coating material by means of a spray gun, in particular a spray gun with one or more of the features described above and/or a material-amount regulating device with one or more of the features described above. According to the method, the material-amount regulating device is placed by means of the adjustment element into a stroke-limiting position in which the stop surface allows the material needle to move in the axial direction as far as a freely definable intermediate position in which a reduced amount of material can be dispensed. This is followed by the application of a coating material layer having a reduced amount of dispensed material. After the coating material layer has been completely applied, a rapid adjustment mechanism of the material-amount regulating device is actuated, by means of which the stop surface is moved from the stroke-limiting position to a stroke-opening position without the adjustment element being actuated, wherein, in the stroke-opening position, the material needle can be opened in the axial direction as far as a maximum position and the maximum possible amount of material can be dispensed (that has not been reduced) or has not been reduced as much. This is followed by the application of another layer of coating material having an amount of dispensed material that has not been reduced. The described method can, for example, be used to achieve a special surface effect. A particularly opaque coating material layer can also be created.

### BRIEF DESCRIPTION OF THE DRAWINGS

In the following, embodiments of the apparatus according to the invention will be explained in more detail on the basis of schematic drawings. In the figures:

FIG. 1 shows a perspective view of a first design of a material-amount regulating device in the stroke-limiting position,

FIG. 2 shows a partial section of the first design of the material-amount regulating device from FIG. 1 in the stroke-limiting position,

FIG. 3 shows a central section of the first design of the material-amount regulating device from FIG. 1 in the stroke-limiting position,

FIG. 4 shows a central section of the first design of the material-amount regulating device from FIG. 1 in the stroke-opening position,

FIG. 5 shows a spray gun having the first design of the material-amount regulating device from FIG. 1 in the stroke-opening position,

FIG. 6 shows a partial section of the spray gun from FIG. 5 having the design of the material-amount regulating device from FIG. 1 in the stroke-limiting position, in which the trigger is not actuated,

FIG. 7 shows a partial section of the spray gun from FIG. 5 having the first design of the material-amount regulating device from FIG. 1 in the stroke-limiting position, in which the trigger is fully actuated,

FIG. 8 shows a partial section of the spray gun from FIG. 5 having the first design of the material-amount regulating device from FIG. 1 in the stroke-opening position, in which the trigger is fully actuated,

FIG. 9 shows a central section of the paint channel of FIG. 6,

FIG. 10 shows a central section of a second design of a material-amount regulating device in the stroke-limiting position,

FIG. 11 shows a central section of the second design of a material-amount regulating device in the stroke-opening position,

FIG. 12 shows a central section of a third design of a material-amount regulating device in the stroke-limiting position,

FIG. 13 shows a central section of the third design of a material-amount regulating device in the stroke-opening position,

FIG. 14 shows a central section of a fourth design of a material-amount regulating device in the stroke-limiting position,

FIG. 15 shows a central section of the fourth design of a material-amount regulating device in the stroke-opening position, and

FIG. 16 shows a side view of the fourth embodiment of a material-amount regulating device in the stroke-opening position.

### DETAILED DESCRIPTION

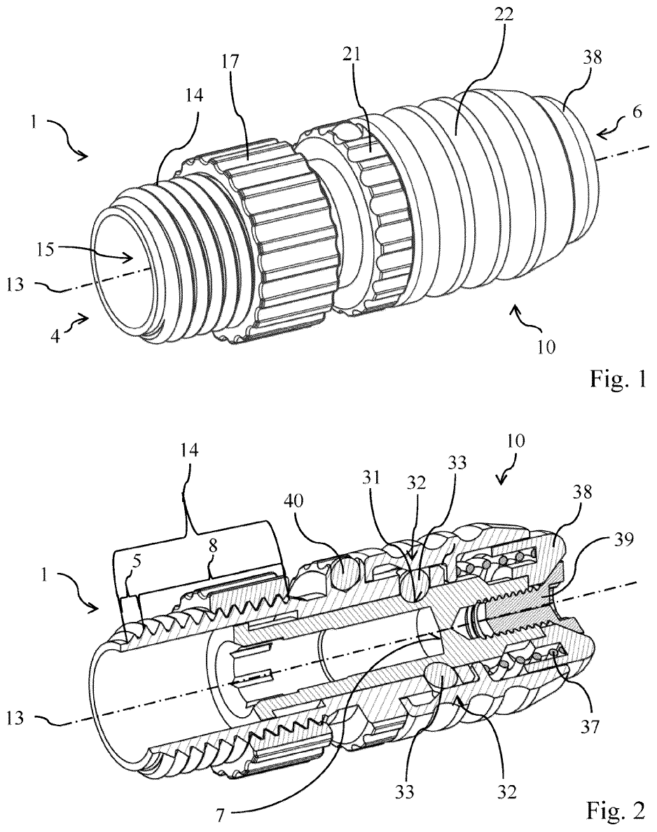

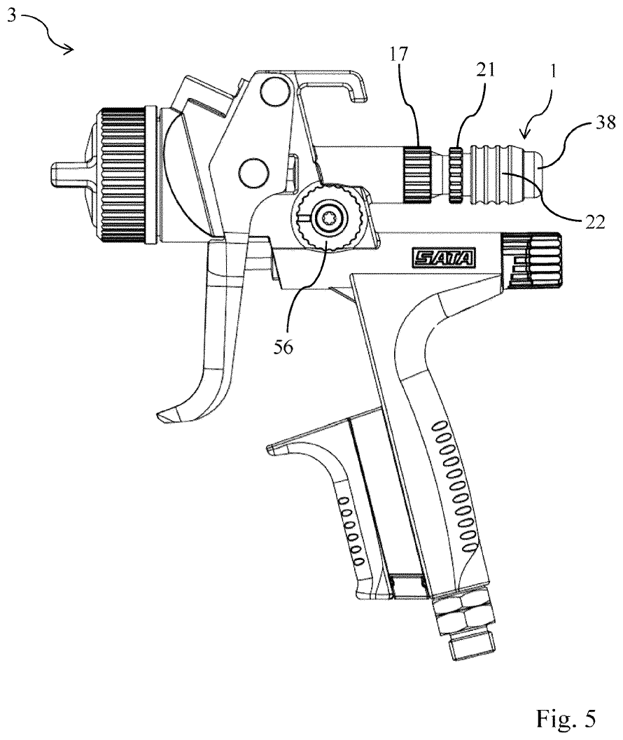

FIGS. 1 to 4 show a material-amount regulating device 1 for limiting the material-needle stroke of a hand-held spray gun 3, as shown by way of example in FIG. 5. The material-amount regulating device 1 has a front end 4 with a holding means 5 in the form of a thread 14, by means of which the material-amount regulating device 1 can be fastened to the spray gun 3 shown in FIG. 5. Also shown is a rear end 6, which is opposite the front end 4. The material-amount regulating device 1 has a stop surface 7 shown in FIGS. 2 to 4 for limiting the material-needle stroke and an adjustment means 8 which is formed by part of the holding means 5 designed as a thread 14.

The axial position of the stop surface 7 for limiting the material-needle stroke can be adjusted by means of the adjustment means 8 and by it interacting with a corresponding counter element 9 of the spray gun 3. Also shown is a rapid adjustment mechanism 10, by means of which the stop surface 7 can be shifted back and forth in the axial direction 13 relative to the adjustment means 8 between a stroke-limiting position and a stroke-opening position, which is different than the stroke-limiting position, without changing the position of the adjustment means 8 and without removing the material-amount regulating device 1 from the spray gun 3.

In the material-amount regulating device 1 shown, the stop surface 7 is offset in the axial direction 13 relative to the holding means 5 in the direction of the rear end 6 of the material-amount regulating device 1. In the stroke-limiting position, the stop surface 7 is closer to the front end 4 of the material-amount regulating device 1 than in the stroke-opening position.

As can be seen from FIGS. 1 to 4, the adjustment means 8 at the front end 4 extends in the direction of the rear end 6. The stop surface 7 for limiting the material-needle stroke can be shifted back and forth in the axial direction 13 between a stroke-limiting position and a stroke-opening position, that is different than the stroke-limiting position, by the rapid adjustment mechanism 10 which is separate from the adjustment means 8. By means of the rapid adjustment mechanism 10, the stop surface 7 can move relative to the adjustment means 8, wherein, in the stroke-limiting position, the stop surface 7 is offset relative to the adjustment means 8 toward the rear end 6 of the material-amount regulating device 1 in the axial direction 13.

As the structure of the material-amount regulating device 1 shows, the stop surface 7 is also offset in the stroke-limiting position relative to the adjustment means 8 toward the rear end 6 of the material-amount regulating device 1. Accordingly, the stop surface 7 is arranged closer to the rear end 6 than to the front end 4 of the material-amount regulating device 1 both in the stroke-limiting position and in the stroke-opening position. In an alternative embodiment, the stop surface 7 can also be arranged at the level of the adjustment means 8 in the axial direction 13 when the material-amount regulating device 1 is in the stroke-limiting position.

As can be seen from FIGS. 1 to 4, a locking means 17 is provided, by means of which the adjustment means 8 can be locked in a position in the axial direction 13, wherein the locking means 17 is designed as a lock nut 17.

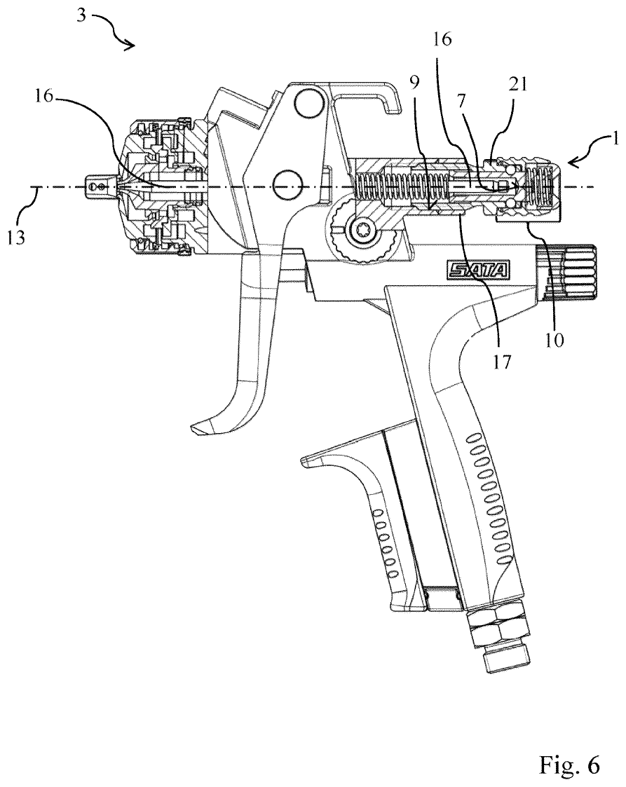

FIGS. 1 to 4 also show a cavity 15 which extends from the front end 4 of the material-amount regulating device 1, in the direction of the rear end 6 of the material-amount regulating device 1 and into the interior of the material-amount regulating device 1. FIGS. 6 to 9 show that the cavity 15 is designed to receive a material needle 16 of the spray gun 3.

Also shown is a sleeve-shaped adjustment element 18, which comprises the adjustment means 8, and a sleeve-shaped stop element 19, which comprises the stop surface 7, wherein the stop element 19 is partially arranged in the interior of the adjustment element 18. Designs are also possible in which the adjustment element 18 is at least partially arranged inside the stop element 19.

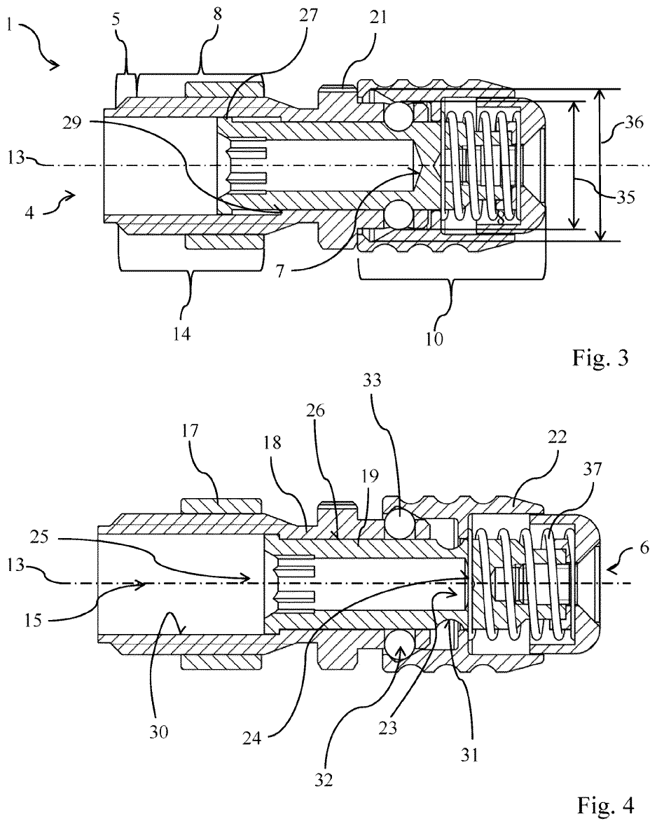

FIG. 3 shows the material-amount regulating device in the stroke-limiting position and FIG. 4 shows the material-amount regulating device in the stroke-opening position. It can be seen from both figures that, in the stroke-limiting position, the stop surface 7 is closer to the front end 4 of the material-amount regulating device 1 in the axial direction 13 than in the stroke-opening position and that, in the stroke-limiting position, the stop surface 7 is positioned within the half of the material-amount regulating device 1 that comprises the rear end 6 of the material-amount regulating device 1.

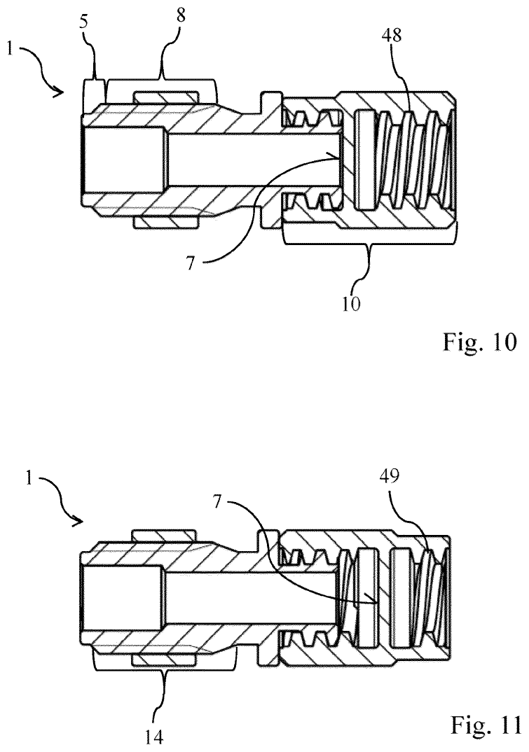

It is also shown that the stop element 19 and the adjustment element 18 each have a shoulder 27, 29 which abut one another in the stroke-opening position and limit the maximum deflection of the stop element 19 to the rear in the stroke-opening position. From the structure shown, it is clear that the stop surface 7 is moved by means of the rapid adjustment mechanism 10 exclusively by the stop surface 7 moving in the axial direction 13. In the case of another design according to the invention, as shown, for example, in FIG. 10 and 11, 12 and 13 or 14 and 15, the movement of the stop surface 7 by means of the adjustment means 8 can also be performed by a rotational movement of an actuating element 21 around the central axis of the material-amount regulating device 1 or a combination of such a rotary movement and a movement in the axial direction 13, as described above.

As can be seen in particular from FIGS. 3 and 4, the rapid adjustment mechanism 10 is designed in such a way that it automatically locks in the stroke-limiting position and the stroke-opening position. For this purpose, the rapid adjustment mechanism 10 comprises a securing element 22 which serves to lock the rapid adjustment mechanism 10 in the stroke-limiting position and the stroke-opening position, wherein the securing element 22 partially surrounds the adjustment element 18 and the stop element 19 in the circumferential direction. The rapid adjustment mechanism 10 is designed in such a way that it automatically moves from the stroke-limiting position into the stroke-opening position by retracting the securing element 22. For this purpose, a spring element 37 is provided which, in combination with a material needle spring 47, exerts a backward force on the stop element 19 and moves it backward when the rapid adjustment mechanism 10 is released by the securing element 22. For this purpose, the securing element 22 is pulled backward in the stroke-limiting position.

As shown in FIGS. 3 and 4, the adjustment element 18 is sleeve-shaped, wherein a sleeve-shaped stop element 19 is provided, regions of which are arranged within the adjustment element 18 and which is coaxially mounted on the inner surface 30 of the sleeve-shaped adjustment element 18. The adjustment element 18 is provided with an external thread 14, shown in detail in FIGS. 1 and 2, which forms the holding means 5 and the adjustment means 8. A locking means 17 in the form of a lock nut 17 is provided on the external thread 14. The stop element 19 is closed at an end 23 opposite the front end 4 of the material-amount regulating device 1. The stop surface 7 is formed on the inside 24 of the closed end 23. In the region of the open end 25 of the stop element 19 that is opposite the closed end 23, the outer surface 26 of the stop element 19 is provided with a shoulder 27. In the stroke-opening position shown in FIG. 4, this shoulder 27 comes to rest with a shoulder 29 on the inner surface 30 of the adjustment element 18 and blocks the stop element 19 from moving in the axial direction 13. In the stroke-opening position, the inner stop element 19 is moved as far as possible in the direction of the rear end 6 of the material-amount regulating device 1.

The stop element 19 has a circumferential groove 31 in the region of the closed end 23. The adjustment element 18 has bores 32 in the rear region in which balls 33 are mounted so as to move radially with respect to the axial direction 13. In a securing position shown in FIG. 3, the position of the bores 32 is at the same level as the position of the circumferential groove 31 in the axial direction 13, wherein the stop element 19 is moved within the adjustment element 18 toward the front end 4.

Furthermore, a sleeve-shaped securing element 22 is shown which surrounds the region of the rear end 6 of the material-amount regulating device 1 in the region of the bores 32 and the circumferential groove 31. The securing element 22 has a larger opening inner diameter 35 that is at the front when viewed in the axial direction 13 and a smaller securing inner diameter 36 that is at the rear when viewed in the axial direction 13. The securing element 22 is mounted so as to be movable in the axial direction 13 relative to the adjustment element 18 and the stop element 19 such that it can be moved back and forth in the axial direction 13 between the securing position shown in FIG. 3 and the opening position shown in FIG. 4.

In the securing position according to FIG. 3, the circumferential groove 31, the bores 32 and the securing inner diameter 36 are at the same level in the axial direction 13. In the opening position from FIG. 4, the circumferential groove 31, the bores 32 and the opening inner diameter 35 are at the same level in the axial direction 13.

In the securing position according to FIG. 3, the balls 33 engage in the circumferential groove 31 of the stop element 19, wherein the mobility of the balls 33 in the radial direction and away from the central axis of the material-amount regulating device 1 is limited by the smaller securing inner diameter 36 in such a way that they are held in engagement with the circumferential groove 31. This prevents the stop element 19 from moving axially relative to the adjustment element 18.

In the opening position according to FIG. 4, due to the larger opening inner diameter 35, the balls 33 can be deflected outward in the radial direction from the central axis of the material-amount regulating device 1 to such an extent that the balls 33 no longer engage in the circumferential groove 31. Thus, the stop element 19 can be moved back and forth in the axial direction 13 relative to the adjustment element 18 between the stroke-limiting position and the stroke-opening position.

Between the stop element 19 and the securing element 22 is the spring element 37, which exerts a force on the stop element 19 directed in the axial direction 13 and in the direction of the rear end 6 of the material-amount regulating device 1, which force automatically shifts the stop element 19 backward from the stroke-limiting position and into the stroke-opening position and holds it in this position.

Conversely, the spring element 37 exerts a force on the securing element 22 which is directed in the axial direction 13 and in the direction of the front end 4 of the material-amount regulating device 1 and which urges the securing element 22 forward in the direction of the securing position. However, the balls 33, which are arranged in the opening inner diameter 35 of the securing element 22, hold the securing element 22 in the open position.

In order to transfer the stop surface 7 or the stop element 19 from the stroke-opening position shown in FIG. 4 into the stroke-limiting position shown in FIG. 3, a pushbutton 38 on the stop element 19 must be actuated and the stop element 19 must thereby be shifted so far toward the front end 4 that the groove 31 is again at the axial level of the balls 33. The balls 33 are now pressed radially inward into the groove 31. The spring element 37 now shifts the unsecured securing element 22 toward the front end 4 and the rapid adjustment mechanism 10 automatically locks in the stroke-limiting position shown in FIG. 3, since the outward radial movement of the balls 33 is limited by the securing inner diameter 36 of the securing element 22 which is now at the level of the balls 33.

In order to move the stop surface 7 or the stop element 19 from the stroke-limiting position shown in FIG. 3 into the stroke-opening position shown in FIG. 4, the securing element 22 is shifted toward the rear end 6 of the material-amount regulating device 1, wherein the spring element 37 is further compressed and the spring force which the spring element 37 exerts on the stop element 19 by means of the pushbutton 38 increases. As soon as the securing element 22 is moved so far toward the rear end 6 of the material-amount regulating device 1 that the opening inner diameter 35 and the balls 33 are at the same axial level, the balls 33 are moved outward in the axial direction by the spring force, whereby the stop element 19 is released and automatically moves backward. The spring force exerted by the spring element 37 on the pushbutton 38 and thus on the stop element 19 holds said stop element in the stroke-opening position, provided that no forward force is exerted on the pushbutton 38 as previously described.

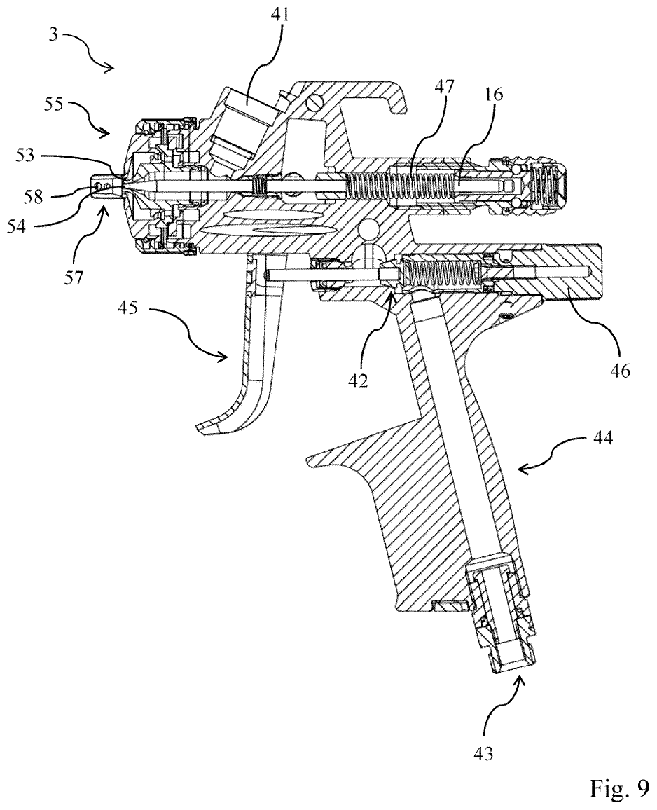

FIG. 5 shows an example of a spray gun 3 for dispensing a coating material. The spray gun shown is a hand-held spray gun 3, having a material needle 16 shown in the sectional view of FIG. 9 and a material-amount regulating device 1 for limiting the material-needle stroke according to FIGS. 1 to 4. The material-amount regulating device 1 is fastened directly to the spray gun 3, but in an alternative embodiment it can also be fastened via at least one intermediate component.

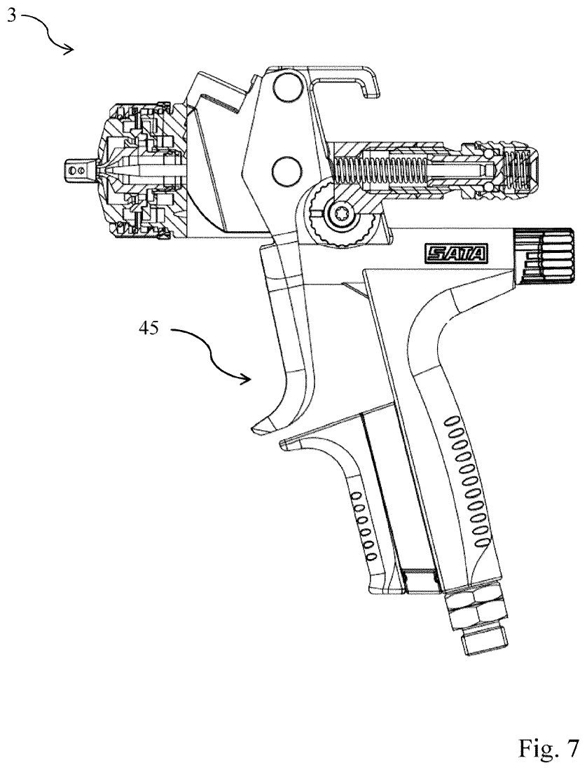

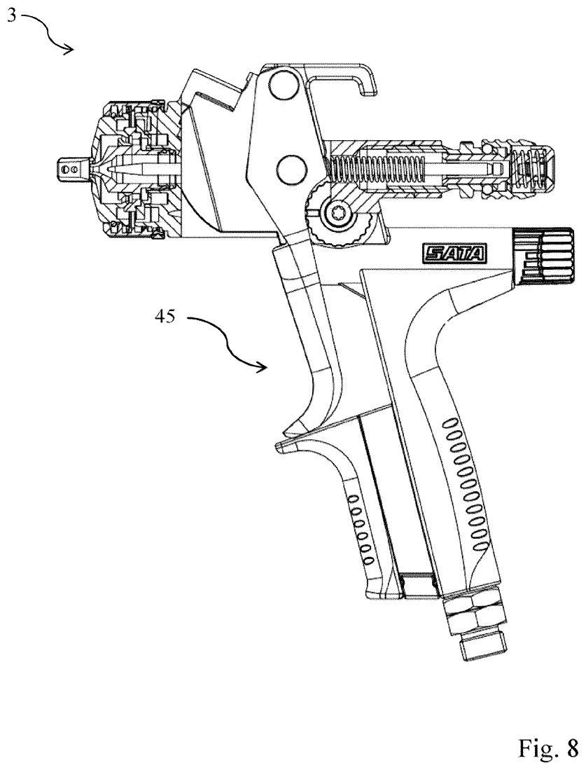

FIGS. 6 to 8 show the spray gun 3 in different material dispensing states. Here, FIG. 6 shows a state with the material needle 16 unopened and in which no coating material is dispensed. FIGS. 7 and 8 show the state when the trigger 45 is fully pulled, with the material-amount regulating device 1 in the stroke-limiting position in FIG. 7 and in the stroke-opening position in FIG. 8.

FIG. 7 shows that, in the stroke-limiting position, the stop surface 7 limits the maximum axial deflection of the material needle 16 in the direction of the rear end 6 of the material-amount regulating device 1 such that a reduced amount of coating material can be dispensed compared to in the stroke-opening position. This becomes particularly clear when viewed in conjunction with FIG. 8, which shows the material-amount regulating device 1 in the stroke-opening position. This shows that the material needle 16 can be moved further back in the stroke-opening position, whereby the material nozzle 54 can be opened further and thus a larger amount of coating material can be dispensed, since the opening cross section between the material nozzle 54 and the material needle 16 is larger. FIG. 8 also shows that the maximum deflection of the material needle 16 in the axial direction 13 and in the direction of the rear end 6 of the material-amount regulating device 1 in the stroke-opening position is not limited by the stop surface 7 to the extent that the maximum possible amount of coating material can be dispensed. In another design, however, the deflection of the material needle 16 can also be limited by the stop surface 7, wherein the deflection of the material needle 16 in the stroke-opening position still being limited less than in the stroke-limiting position.

The application of the coating material by means of a spray gun 3 preferably begins by first moving the material-amount regulating device 1 into a closed position (not shown) by means of the adjustment element 18, in which the material-amount regulating device 1 is completely closed. In this position, the stop surface 7 of the material-amount regulating device 1 completely blocks the movement of the material needle 16 of the spray gun 3 in the axial direction 13 (zero or starting position).

Subsequently, the material-amount regulating device 1 is placed by means of the adjustment element 18 into the stroke-limiting position shown, for example, in FIG. 4, in which position the stop surface 7 allows the material needle 16 to move in the axial direction 13 as far as an intermediate position shown in FIG. 7, in which a reduced amount of material can be dispensed.

This is followed by the actuation of the rapid adjustment mechanism 10 of the material-amount regulating device 1, by means of which the stop surface 7 is moved from the stroke-limiting position into the stroke-opening position shown in FIG. 4 without the adjustment element 18 being actuated, in which stroke-opening position the material needle 16, as shown in FIG. 8, can be opened in the axial direction 13 as far as a maximum position and an amount of material can be dispensed that has not been reduced.

After the rapid adjustment mechanism 10 has been actuated and the material-amount regulating device 1 has been brought into the stroke-opening position, a lower coating material layer having an amount of dispensed material that has not been reduced is now applied to the object to be coated.

The rapid adjustment mechanism 10 is then actuated again, whereby the stop surface 7 is moved back into the stroke-limiting position without the adjustment element 18 being actuated, wherein a reduced amount of material can now be dispensed.

After the rapid adjustment mechanism 10 has been actuated and the material-amount regulating device 1 has thereby been brought into the stroke-limiting position, an upper coating material layer is now applied to the object with a reduced amount of dispensed material.

In an alternative design, the coating material is applied by means of the spray gun 3 by first applying a lower (first) coating material layer with a reduced amount of dispensed material by means of the material-amount regulating device 1 in the stroke-limiting position and then applying a further coating material layer with the maximum possible amount of material dispensed to the first coating material layer by means of the material-amount regulating device 1 in the stroke-opening position.

FIG. 9 shows a central section of the spray gun from FIGS. 5 to 8, with the material-amount regulating device 1 in the stroke-limiting position shown in FIG. 3. The spray gun 3 has a coating agent inlet 41 on which a material supply device that supplies the spray gun 3 with coating material can be mounted. In the spray gun 3 shown, a flow cup can be mounted on the coating agent inlet 41. Also shown is an air valve 42, by means of which the air flow through the spray gun 3 can be controlled. An air supply connection 43 is provided for supplying the spray gun 3 with compressed air. The spray gun 3 further comprises a gun handle 44 by which the spray gun 3 can be held by the user. Furthermore, a trigger 45 is provided, by means of which the air valve 42 as well as the deflection of the material needle 16 and thus the amount of material dispensed are controlled. Also shown is an air-volume regulating device 46, by means of which the amount of compressed air that passes from the air supply connection 43 to the air valve 42 can be set. By means of the material needle spring 47, the material needle 16 is subjected to a spring force in the material dispensing direction in order to move it forward again when the trigger 45 is released. Also shown is an air nozzle 53, which surrounds the round material nozzle 54 (also shown) in the form of an annular gap and atomizes the coating material emerging from the material nozzle 54. Both the material nozzle 54 and the air nozzle 53 are located on the nozzle head 55. Horns 57 projecting in the material dispensing direction are also provided on the nozzle head 55 and carry the horn air nozzles 58. The round/wide jet regulator 56 can be used to control how much air flows out of the horn air nozzles 58 when the trigger 45 is actuated.

FIGS. 10 to 16 show alternative embodiments of a material-amount regulating device 1 according to the invention. However, many other embodiments are conceivable, which are also considered to correspond to the invention.

FIGS. 10 and 11 show a second design of a material-amount regulating device 1. Deviating from the previously described embodiment, the stop element 19 has a rapid adjustment mechanism 10 which is formed by a first rapid thread 48 and a second rapid thread 49. The first quick thread 48 is longer than the second rapid thread 49. If the rapid adjustment mechanism is in the stroke-limiting position shown in FIG. 10, the stop element 19 is connected to the adjustment element 18 by means of the shorter second rapid thread 49. If the rapid adjustment mechanism 10 is switched to the stroke-opening position, the stop element 19 is unscrewed from the adjustment element 18 by means of the second rapid thread 49, whereupon the stop element 19 is screwed onto a thread of the adjustment element 18 using the first rapid thread 48. Due to the different lengths of the first rapid thread 48 and the second rapid thread 49, the stop surface 7 is further away from the front end 4 of the material-amount regulating device 1 in the stroke-opening position than in the stroke-limiting position.

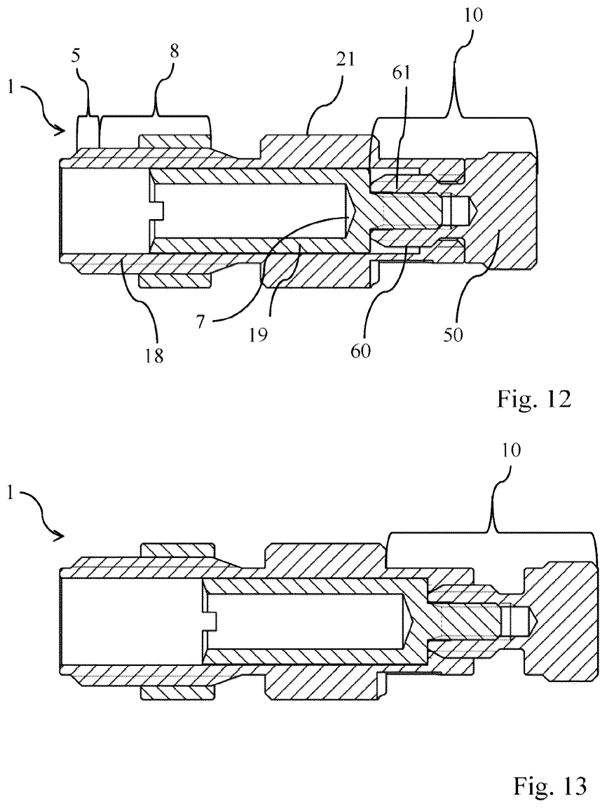

FIGS. 12 and 13 show a further embodiment of a material-amount regulating device 1, which differs from the previously described embodiments in that the stop element 19 and the adjustment element 18 are connected via a threaded knob 50, which bears an external thread 60 at its front end, by means of which the threaded knob 50 is connected to the adjustment element 18 in such a way that the threaded knob 50 can be moved forward or backward relative to the adjustment element 18 when rotated about its own axis via the thread 60. The threaded knob 50 has an inner bore 61 at its front end, in which the stop element 19 is mounted such that it can rotate freely but is interlocked in the axial direction 13 such that the stop element 19 together with the threaded knob 50 moves forward and backward relative to the adjustment element 18 when the threaded knob 50 is rotated to the right or left in the circumferential direction. In this way, the stop surface 7 on the stop element 19 can be moved relative to the adjustment element 18 from a stroke-limiting position (FIG. 12) into a stroke-opening position (FIG. 13).

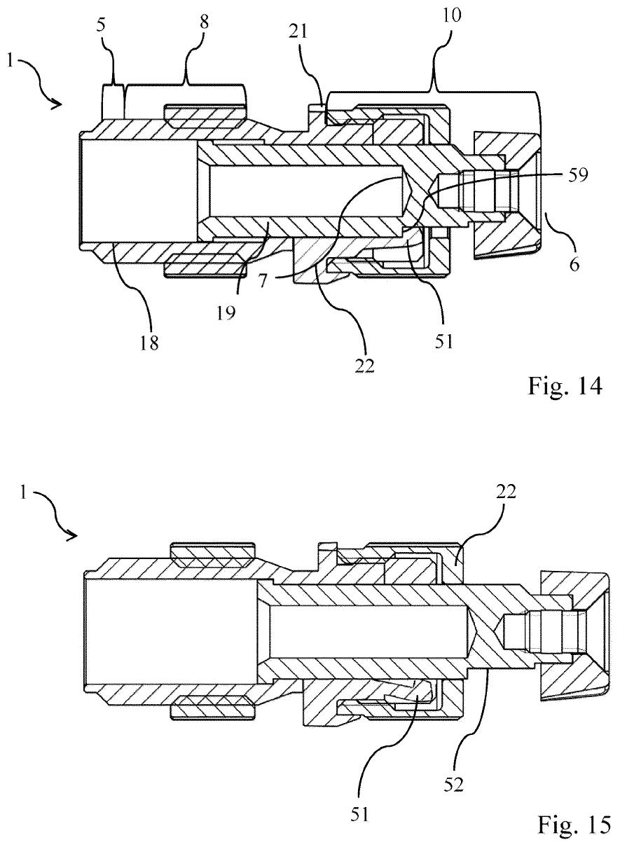

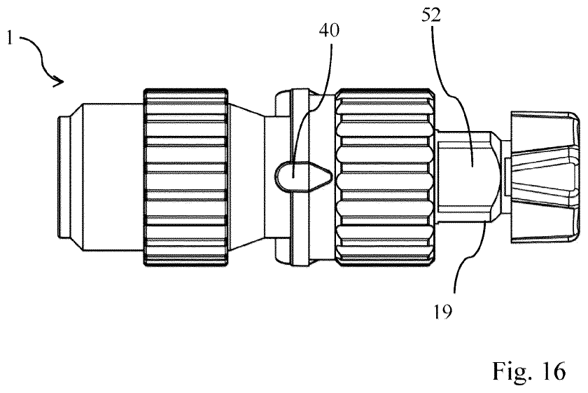

FIGS. 14 to 16 show a further embodiment of a material-amount regulating device 1. In this embodiment, part of the stop element 19, as can be seen from FIG. 16, is designed to be substantially triangular in cross section such that the side surfaces of the triangular part form a recess offset 52. At the front end of the recess offset 52, the triangular cross section changes to a round cross section whose outer diameter lies on the vertexes of the triangular cross section. The transition between the triangular cross section and the round cross section forms a recess offset shoulder 59 on the sides of the triangle. Furthermore, an intermediate securing element 22 is provided with a snap hook 51, which is designed such that it engages with the recess offset shoulder 59 in the stroke-limiting position shown in FIG. 14 when the angular position of the recess offset shoulder 59 and the snap hook 51 with respect to the axis of the material-amount regulating device 1 coincide. In this way, the stop element 19 is held in the stroke-limiting position, even if the material needle 16 or, if applicable, the material needle spring 47 presses backward directly on the stop element 19 in the axial direction 13.

To transfer the stop element 19 into the stroke-opening position (FIG. 15), the stop element 19 is rotated about its own axis until the snap hook 51 is moved outward to such an extent that it is located on the round outer diameter of the stop element 19 and disengages from the rebound offset shoulder 59. The force directly exerted by the material needle 16 or the material needle spring 47 on the stop element 19 then shifts the latter into the stroke-opening position.

If a force is exerted on the rear end 6 of the material-amount regulating device 1, the stop element 19 can be moved forward again and secured in the stroke-limiting position by rotating about its own axis. In the same way as the other embodiments, the material-amount regulating device 1 can have a position marking 40 which indicates the angular position of the material-amount regulating device 1 with respect to the spray gun.

In reference to the figures and the above embodiments, preferred embodiments of the invention are described only by way of example. Other designs, materials or types of connection are conceivable and will be evident to those skilled in the art when reading the embodiments and the prior art. All individual features of the embodiments can be combined with one another, even if this is not explicitly mentioned. This also relates to the embodiments per se. A person skilled in the art clearly recognizes if a combination is not possible or not useful. All embodiments can be applied to different types of spray guns, even if this is not explicitly described.

### LIST OF REFERENCE SIGNS

1. material-amount regulating device
3. spray gun
4. front end (of the material-amount regulator)
5. holding means (of the material-amount regulator)
6. rear end (of the material-amount regulator)
7. stop surface
8. adjustment means (of the material-amount regulator)
9. counter element of the spray gun
10. rapid adjustment mechanism
13. axial direction
14. thread
15. cavity
16. material needle
17. locking means
18. adjustment element
19. stop element
21. actuating element (for rotational movement)
22. securing element
23. closed end of the stop element
24. inside of the closed end of the stop element
25. open end of the stop element
26. outer surface of the stop element
27. shoulder of the stop element
29. shoulder of the adjustment element
30. inner surface of the adjustment element
31. circumferential groove
32. bores
33. balls
35. opening inner diameter
36. securing inner diameter
37. spring element
38. pushbutton
39. connecting screw
40. position marking
41. coating agent inlet
42. air valve
43. air supply connection
44. gun handle
45. trigger
46. air-volume regulating device
47. material needle spring
48. first rapid thread
49. second rapid thread
50. threaded knob
51. snap hook
52. rebound offset
53. air nozzle
54. material nozzle
55. nozzle head
56. round/wide jet regulation
57. horns
58. horn air nozzle
59. recess offset shoulder
60. external thread of the threaded knob
61. inner bore in the threaded knob

1-19. (canceled)

20. A material-amount regulating device for limiting a material-needle stroke of a material-needle of a hand-held spray gun, the device comprising:
a front end having a fastening member to removably fastening the material-amount regulating device to the spray gun;
a rear end opposite the front end;
a stop surface for limiting the material-needle stroke;
an adjustment member operatively associated with the fastening member, via which, by interacting with a corresponding counter element of the spray gun, rotation of the adjustment means moves the fastening member to adjust an axial position of the stop surface relative to the spray gun to alter the material-needle stroke; and
a rapid adjustment member, by means of which the stop surface can be selectively changed from a stroke-limiting position which provides for movement of the material-needle of a first stroke length and a stroke-opening position which provides for movement of the material-needle of a second stroke length without rotation of the adjustment member and without movement of the fastening member and without removing the material-amount regulating device from the spray gun,
wherein the second stroke length is longer than the first stroke length; and
wherein at least in the stroke-limiting position, the stop surface is arranged at the level of the fastening member in the axial direction or is offset in the axial direction relative to the fastening member in the direction of the rear end of the material-amount regulating device.

21. The material-amount regulating device according to claim 20, wherein the fastening member comprises threading.

22. The material-amount regulating device according to claim 21, wherein the threading forms at least a portion of the adjustment member.

23. The material-amount regulating device according to claim 20, wherein the fastening member is separate from the adjustment member.

24. The material-amount regulating device according to claim 20, wherein at least in the stroke-limiting position, the stop surface is arranged closer to the rear end than to the front end of the material-amount regulating device and wherein the stop surface is closer to the front end in the axial direction in the stroke-limiting position than in the stroke-opening position.

25. The material-amount regulating device according to claim 20, wherein the material-amount regulating device has a cavity which extends from the front end toward the rear end and into an interior of the material-amount regulating device and is designed to receive the material-needle of the spray gun.

26. The material-amount regulating device according to claim 20, wherein a locking member is provided, by means of which the material-amount regulating device can be locked in a position set by the adjustment member in the axial direction relative to the spray gun.

27. The material-amount regulating device according to claim 26, wherein the locking member comprises a lock nut.

28. The material-amount regulating device according to claim 20, wherein an adjustment element is provided, which comprises the adjustment member and a stop element is provided, which comprises the stop surface, the stop element and the adjustment element being displaceable relative to one another in the axial direction.

29. The material-amount regulating device according to claim 28, wherein the stop element and the adjustment element each have a shoulder which abut one another in the stroke-opening position.

30. The material-amount regulating device according to claim 20, wherein the material-amount regulating device is designed such that the stop surface is moved by at least one of the rapid adjustment member moving the stop surface in the axial direction and adjustment member moving the stop surface in the axial direction by a screwing movement around a central axis of the material-amount regulating device.

31. The material-amount regulating device according to claim 20, wherein the rapid adjustment member is designed such that the rapid adjustment member automatically locks in the stroke-limiting position and/or the stroke-opening position.

32. The material-amount regulating device according to claim 28, wherein the rapid adjustment member comprises a securing element which locks the rapid adjustment member in at least one of the stroke-limiting position and the stroke-opening position.

33. The material-amount regulating device according to claim 32, wherein the securing element at least partially surrounds at least one of the adjustment element and the stop element in a circumferential direction.

34. The material-amount regulating device according to claim 20, wherein the material-amount regulating device has a sleeve-shaped adjustment element and a sleeve-shaped stop element, regions of which are arranged within the adjustment element and which is coaxially mounted on an inner surface of the adjustment element, the adjustment element being provided with an external thread which forms the fastening member and the adjustment member, a locking member in the form of a lock nut being provided on the external thread, the stop element being closed at an end that is opposite the front end of the material-amount regulating device and the stop surface being formed on an inside of the closed end, an outer surface of the stop element is provided with a shoulder in a region of an open end of the stop element that is opposite the closed end, which shoulder, in the stroke-opening position in which the stop element is shifted as far as possible in the direction of the rear end of the material-amount regulating device, comes to rest with a shoulder on the inner surface of the adjustment element and blocks movement of the stop element in the axial direction from the front end of the material-amount regulating device in the direction of the rear end of the material-amount regulating device.

35. The material-amount regulating device according to claim 34, wherein the stop element has a circumferential groove and the adjustment element has bores, in which balls are mounted so as to move radially with respect to the axial direction, an additional sleeve-shaped securing element being provided which surrounds the region of the rear end of the material-amount regulating device in the region of the bores and the circumferential groove and has a larger opening inner diameter at the front when viewed in the axial direction and a smaller securing inner diameter at the rear when viewed in the axial direction, the additional sleeve-shaped securing element being shiftable back and forth in the axial direction relative to the adjustment element and the stop element between a securing position and an opening position, the circumferential groove, the bores and the securing inner diameter being at the same level in the axial direction when the additional sleeve-shaped securing element is arranged in the securing position and the stop element is arranged in the stroke-limiting position relative to the adjustment element, as a result of which the balls are pressed radially inward into the groove in the stop element by the securing inner diameter of the additional sleeve-shaped securing element and the stop element is thereby locked in the stroke-limiting position relative to the adjustment element, and the bores together with the balls mounted therein and the opening inner diameter of the additional sleeve-shaped securing element being at the same level in the axial direction when the additional sleeve-shaped securing element is arranged in the opening position, as a result of which the balls can be moved radially outward from the groove in the stop element into the opening inner diameter, and the stop element can thereby be shifted back and forth in the axial direction relative to the adjustment element between the stroke-limiting position and the stroke-opening position.

36. The material-amount regulating device according to claim 35, wherein a spring element is provided, via which the stop element and the additional sleeve-shaped securing element are supported against one other in the axial direction.

37. A hand-held spray gun for dispensing a coating material, the spray gun comprising a material needle and the material-amount regulating device according to claim 20, wherein the material-amount regulating device is fastened directly to the spray gun or via an intermediate component.

38. A method for applying coating material by means of the spray gun according to claim 37, the method comprising:
placing the material-amount regulating device by means of the adjustment member into the stroke-limiting position in which the stop surface allows the material needle to move in the axial direction up to an intermediate position, in which position a reduced amount of material can be dispensed,
actuating the rapid adjustment member of the material-amount regulating device, by means of which the stop surface is moved from the stroke-limiting position to the stroke-opening position without the adjustment member being actuated, in which stroke-opening position the material needle can be opened in the axial direction as far as a maximum position and the maximum possible amount of material can be dispensed,
applying a coating material layer containing the maximum possible amount of dispensed material,
actuating the rapid adjustment member, by means of which the stop surface is returned to the stroke-limiting position, in which the reduced amount of material can be dispensed, without the adjustment member being actuated, and
applying a coating material layer comprising the reduced amount of dispensed material.

39. A method for applying coating material by means of the spray gun according to claim 37, the method comprising:
placing the material-amount regulating device into the stroke-limiting position by means of the adjustment member, in which position the stop surface allows the material needle to move in the axial direction up to an intermediate position in which a reduced amount of material can be dispensed,
applying a coating material layer comprising the reduced amount of dispensed material,
actuating the rapid adjustment member of the material-amount regulating device, by means of which the stop surface is moved from the stroke-limiting position to the stroke-opening position without the adjustment member being actuated, in which stroke-opening position the material needle can be opened in the axial direction as far as a maximum position and the maximum possible amount of material can be dispensed, and
applying a coating material layer comprising the maximum possible amount of dispensed material.
